(19) United States
(12) Patent Application Publication
(10) Pub. No.: US 2004/0167962 A1
(43) Pub. Date: Aug. 26, 2004

(54) Time sensitive data exchange in ad-hoc reconfigurable networks

(76) Inventor: Joseph K. Woelfel, Watertown, MA (US)

Correspondence Address: Patent Department, Mitsubishi Electric Research Laboratories, Inc., 201 Broadway, Cambridge, MA, 02139, US

(21) Appl. No.: 10/374,116

(22) Filed: Feb. 25, 2003

(51) Int. Cl. G06F 15/16

(52) U.S. Cl. 709/205

(57) ABSTRACT

A method transfers data among a terminals connected by a network. The method for each terminal includes the following steps. A configuration of the network is maintained in the terminal. The configuration includes identifications particular terminals registered in the configuration. Data generated by an application executing in the terminal are sent to one or more identified terminals registered in the configuration, and for the application are received from one or more of the identified terminals registered in the configuration.

### FIELD OF THE INVENTION

The present invention relates generally to communication networks, and more particularly to exchanging time-sensitive data in ad-hoc reconfigurable networks.

### BACKGROUND OF THE INVENTION

Many modern networks operate in an ad-hoc manner. In an ad-hoc network, terminals communicate with each other without any network infrastructure or centralized administration. The configuration of the ad-hoc network can be static or dynamic, or combinations thereof. The terminals can be cellular telephones, portable computing devices, end-user terminals, or special purpose devices such as sensors. Terminals can enter and exit the network at will. The terminals in such networks are required to establish routing among themselves, without relying on centralized management, such as name servers.

Over the years, numerous protocols, e.g., RPC, FTP, DCOM, CORBA, SOAP, HTML, XML, JINI, JXTA, TCP/IP, UDP/IP, to name but a few, have been developed to exchange data for traditional network applications, such as file transfer, Web browsing, e-mail, and the like. Typically, a “best-effort” approach is sufficient for most applications. That is, an e-mail can be delivered now, or five minutes from now. Generally, it is also a goal of those protocols to make the complex operation of the network transparent to the applications that use them.

However, most of the prior art protocols are insufficient for many non-traditional applications found in ad-hoc networks. For example, factory and environmental sensors can acquire time sensitive data that need to be processed as soon as possible, five minutes late could be disastrous. Users demand a smooth and uninterrupted delivery of streaming multimedia data, such as videos. In addition, mission critical applications require a high degree of fault tolerance.

The known protocols are inadequate for many applications operating in ad-hoc networks for a number of reasons. The extra overhead inherent in remote procedure calls and arrival guarantees used by conventional protocols makes their use for time sensitive data or streaming data difficult, if not impossible. Furthermore, prior art applications are not concerned with maintaining routing information, they assume that that is the responsibility of the network.

Therefore, it is desired to provide a method and system that can overcome the problems associated with prior art network management techniques. The method should support efficient transfer of time sensitive data, be fault tolerant, support ad-hoc networks, and be independent of specific hardware and software found in network components, particularly when the network is reconfigured dynamically as terminals enter and exit the network.

### SUMMARY OF THE INVENTION

It is an object of the invention to provide a method for sending and receiving time sensitive data in networks, including ad-hoc networks.

It is an object of the invention that the method is independent of specific hardware components, and specific system and application software.

It is an object of the invention to acquire and maintain a configuration of ad-hoc networks without affecting the entire network.

It is an object of the invention to minimize network errors and failures.

More particularly, a method transfers data among a terminals connected by a network. The method for each terminal includes the following steps. A configuration of the network is maintained in the terminal. The configuration includes identifications particular terminals registered in the configuration. Data generated by an application executing in the terminal are sent to one or more identified terminals registered in the configuration, and for the application are received from one or more of the identified terminals registered in the configuration.

### BRIEF DESCRIPTION OF THE DRAWINGS

FIG. 1 is a flow diagram of a method and system for sending and receiving time sensitive data over an ad-hoc network according to the invention.

### DETAILED DESCRIPTION OF THE PREFERRED EMBODIMENT

System Structure

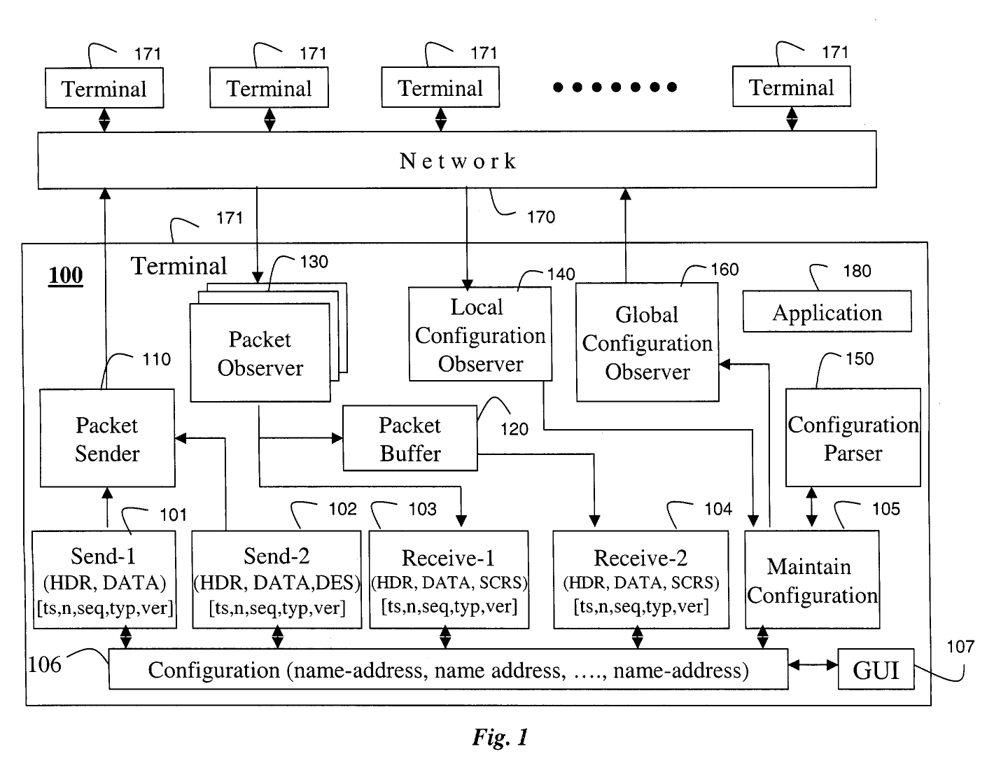

FIG. 1 shows a method and system 100 for transferring time sensitive data among terminals 171 of a network 170. The method and system 100 according to the invention are designed to operate in the terminals 171, executing an application 180.

The data can include time sensitive data, meaning that either the data need be delivered as soon as possible, e.g., real-time sensor data, or the data need to be delivered in a temporally smooth manner without interruption, e.g., video data.

The terminals 171 can be computers, sensors, special purpose device, or end-user terminals, such a cellular telephones. The network can be fixed or ad-hoc. The method and system 100 include send data functions 101-102, receive data call-back functions 103-104, and a maintain configuration function 105, described in greater detail below. The method also uses procedures 110, 130, 140, 150, and 160 described in greater detail below.

The method and system can be used by the application 180 executing in one of the terminals 171 without the application 180 having to track the reconfiguration of the network.

The invention can be used to send and receive real-time or streaming data. The method maintains a current configuration 106 of the network 170. Maintaining the configuration 106 means that the terminal 171 not only acquires a configuration of the network for itself, but also provides periodic updates of the network configuration to other terminals.

System Functions

Send

The system according to the invention provides two functions 101-102 for sending data via a packet sender 110. A call by the application 180 to the first send function (send-1) 101 uses two parameters: a pointer to a packet header (HDR), and a pointer to a data (DATA). The packet header contains a time stamp (ts), the number of bytes of the data (n), a packet sequence number (seq), a type for the packet (typ), and a version number (ver) for the packet header.

The send-1 function 101 sends data to all terminals with registered identifications in the configuration 106. The registration of terminal identifications is described below as part of the maintain configuration function 105.

In another embodiment, channels through which the data are passed also have registered identifications in the configuration 106. Data sent on a particular registered channel or channels may be received by terminals listening to the particular channel using the registered channel identification.

A call to the second send function (send-2) 102 has the same parameters as the first function 101, and an additional parameter that specifies a single registered terminal.

Receive

There are also two call-back functions (103-104) for receiving data. The call-back functions are defined by the application 180. Parameters of the call-back function (receive-1) 103 include a packet header (HDR), packet data (DATA), and the registered name of a source address (SRCS). The headers are constructed as described above.

The call-back function (receive-2) 104 has parameters similar to call-back function (receive-1) 103 except that all parameters are arrays instead of single values. The arrays correspond to an array of packets with identical time stamps.

Packets passed to the call-back function (receive-2) 104 are buffered in a packet buffer 120, as described in greater detail below. Packets passed to the call-back function (receive-1) 103 are not buffered.

Packet Buffer

The packet buffer 120 fulfills several goals. A first goal is to process streaming data smoothly. For example, when receiving a sequence of frames recorded at 15 frames-per-second (fps), the frames should displayed at a smooth 15 fps, even if there is significant jitter in the network. A second goal is that two packets with identical time stamps arriving at different times are synchronized so that they are processed at the same time. A third goal is to discard old packets when processing is too slow. A fourth goal is to manage differences between timing clocks of different terminals, even if the time differences are very large.

Incoming time stamps are assumed to come from a sending terminal's clock that is not necessarily synchronized to the clock of the receiving terminal. The time of the receiving terminal's clock might be 4:59:02, while the time of the sending terminal is 5:02:39.

The method can delay received packets by a varying amount of time in the packet buffer 120. Packets that arrive earlier than expected are held longer in the buffer. Packets that arrive later than expected are held for a shorter amount of time. The buffer size is measured in units of delay time, e.g., the delay time is five seconds.

First, an arrival delta time is measured. The arrival delta time is a difference between the time stamp of the incoming packet and the current time of the receiving terminal. Next, earlier arrived (the older) packets in the buffer are scheduled to be sent to the call-back function (receive-2) 104 at a time equal to the packet's time stamp+arrival delay time+buffer time delay. All packets for which this time is significantly in the past can be discarded.

Packets that arrive so late that the packets would need to reside in the buffer for a negative amount of time are used to re-estimate the arrival delta time. Packets that are so early that they would need to reside in the buffer for an amount of time longer than the buffer delay time are used to reset the length of the buffer delay time, or are discarded if this would make the buffer delay time larger than a predetermined threshold delay time.

To reduce processing requirements, the packet buffer 120 is only used by the call-back function (receive-2) 104.

Maintain Configuration

The maintain configuration function 105 updates the current configuration 106 of the network 170. This function can operate in call or call-back mode. The application 180 can call this function to update the configuration 106, or the function responds to configuration messages received from other network terminals 171. All configuration updates, whether generated locally or remotely, are intercepted by the local application for approval, or for application specific processing.

The maintain configuration function receives registration messages from other terminals 171. The registration messages include identifications of the terminals. Each terminal identification can include a logical name, e.g., a character strings (temperature_sensor_T) and an associated network (IP) physical addresses, e.g., groups of numbers (171.23.203.334). After a terminal has been registered, the application can transfer data with that terminal.

The maintain configuration function can also receive registration messages from the application. These registration messages are channel identifications. After a channel has been registered, any terminal monitoring the channel using the registered channel identifications can transfer data with that channel.

Packets received from a particular address are differentiated by name. By using logical names, the application 180 can be made independent of a changing network configuration. Names also enable the routing of messages to different addresses without changing the application.

System Procedures

Packet Sender

The packet sender 110 tracks all identifications for terminals registered in the configuration 106. The packet sender 110 is used by the send functions 101-102 to send packets to other terminals 171.

Packet Observer

A set of packet observers 130 monitors a specific set of source addresses and forwards the packets to receive call-back functions defined by the applications 180.

The packet buffer 120 is used to remove jitter from received packets, and to synchronize packets before the packets are forwarded to the synchronized receive function 103. Packets forwarded to call-back function (receive-1) 103 bypass the packet buffer 120. Packets forwarded to call-back function (receive-2) 104 pass through packet buffer 120, as described above.

Local Configuration Observe

A local configuration observer 140 acquires configuration messages from other terminals 171 via the network 100. The configuration messages are forwarded to the maintain configuration function 105. The messages received by local configuration observer 140 change the behavior of the local application 180, e.g., local receive and send addresses, and applications settings. The local configuration observer 140 detects a terminal identification that is unique to the local application 180.

Configuration Parser

The configuration parser 120 parses the configuration messages so that the configuration 106 can be maintained.

Discovery

The local configuration observer 140 is also used to support “discovery” for the application. Periodically, e.g., once a second, the local configuration observer 140 generates a multicasts message that includes current configuration information, known to itself, using a predefined multicast address. The configuration message contains application specific configuration information, including names and addresses of other registered terminals, its own name and address, and address information for altering its current configuration settings. All terminals and applications use the same predefined multicast address for discovery.

Global Configuration Observer

A global configuration observer 160 detects the predefined multicast address to which all configuration observers 140 send. The global configuration observer 160 maintains a list of all configuration observers 140 from which it has received multicast messages, the configuration information for each local configuration observer 140's application, and the local address for the local configuration observer.

As new applications appear to the global configuration observers 160, they are discovered. The global configuration observers 160 also keep track of the last time of contact with each local configuration observer. If a remote local configuration observer has not been heard from, during a substantial amount of time, it can be deleted from the configuration 106. Deletion can be intended or unintended, due to a failure. Thus, the global configuration observers 160 can maintain the network configuration as it changes dynamically.

Graphic User Interface

A graphic user interface 107 enables a user to expressly monitor and modify the configuration 106.

Effect of the Invention

The method and system as described above can be used in a number of distributed applications that have a need to send and receive time sensitive or streaming data, e.g., surveillance systems, factory automation systems, teleconferencing systems, and multimedia content distribution systems.

As an advantage, the system according to the invention can perform automatic discovery of network terminals, the synchronization of time sensitive data from multiple sources, and is resistant to network errors.

It is to be understood that various other adaptations and modifications may be made within the spirit and scope of the invention. Therefore, it is the object of the appended claims to cover all such variations and modifications as come within the true spirit and scope of the invention.

I claim:

1. A method for transferring data among a plurality of terminals connected by a network, the method for each terminal comprising the steps of:
maintaining a configuration of the network in the terminal, the configuration including identifications particular terminals registered in the configuration;
sending data generated by an application executing in the terminal to one or more identified terminals registered in the configuration; and
receiving data for the application from one or more of the identified terminals registered in the configuration.

2. The method of claim 1 wherein the data are time sensitive data.

3. The method of claim 1 wherein the time sensitive data are real-time data.

4. The method of claim 1 wherein the data are streaming data.

5. The method of claim 1 wherein the data are transferred as packets, and wherein each packet includes a header and data, and wherein the header includes a time stamp, a number of bytes of the data in the packet, a packet sequence number, a type for the packet, and a version number for the packet header.

6. The method of claim 1 wherein data are sent to registered terminals.

7. The method of claim 1 further comprising:
sending data generated by an application executing in the terminal to one or more identified channels registered in the configuration; and
receiving data for the application from one or more of the identified channels registered in the configuration.

8. The method of claim 1 wherein data are sent to a particular registered terminal.

9. The method of claim 4 wherein the streaming data are buffer in a packet buffer.

10. The method of claim 1 wherein the identification includes a logical name and a physical address of the terminal.

11. The method of claim 1 further comprising:
sending periodically a configuration message to a multicast address of the network, the configuration message including the identification of the terminal.

12. The method of claim 11 further comprising:
receiving periodically the configuration address from other terminal in the network.

12. The method of claim 1 further comprising:
expressly monitor and modify the configuration via a graphic user interface.

13. A system for transferring data among a plurality of terminals connected by a network, comprising:
a memory storing a network configuration including identifications of particular terminals registered in the configuration;
means for sending data generated by an application executing in the terminal to one or more identified terminals registered in the configuration; and
means for receiving data for the application from one or more of the identified terminals registered in the configuration.
